(19) United States
(12) Patent Application Publication
(10) Pub. No.: US 2005/0228656 A1
(43) Pub. Date: Oct. 13, 2005

(54) Audio coding

(76) Inventor: Albertus Cornelis Den Brinker, EINDHOVEN (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,746

(22) PCT Filed: May 16, 2003
(86) PCT No.: PCT/IB03/02044

§ 371 Date: Nov. 24, 2004

(30) Foreign Application Priority Data
May 30, 2002 (EP) 02077128.3

(51) Int. Cl. G10L 19/14

(52) U.S. Cl. 704/224

(57) ABSTRACT

A method of encoding (14) an audio signal (x(n)) is disclosed. The method comprises the step of modelling (16) the audio signal in accordance with a frequency sensitizing parameter (( ) to provide a set of infinite impulse response (IIR) filter type characteristics ((0 . . . k−1) of an order K and capable of being linearly combined with the sensitizing parameter (( ) to provide an estimate ( ) for the audio signal (x(n)), the IIR type filter model satisfying the requirements of a minimum phase filter. The set of characteristics ((0 . . . k−1) of order K are transformed as a function of the sensitizing parameter (( ) to provide a set of characteristics (c0 . . . k) of order K+1 compatible with finite impulse response (FIR) filter type characteristics satisfying the requirements of a minimum phase filter. The set of characteristics (c0 . . . k) of order K+1 are normalised to provide a set of characteristics (d1 . . . k) of order K. An encoded audio stream (50) is generated to include representations (LAR,LSFs) of the normalised set of characteristics (d1 . . . k) of order K.

The present invention relates to coding and decoding audio signals.

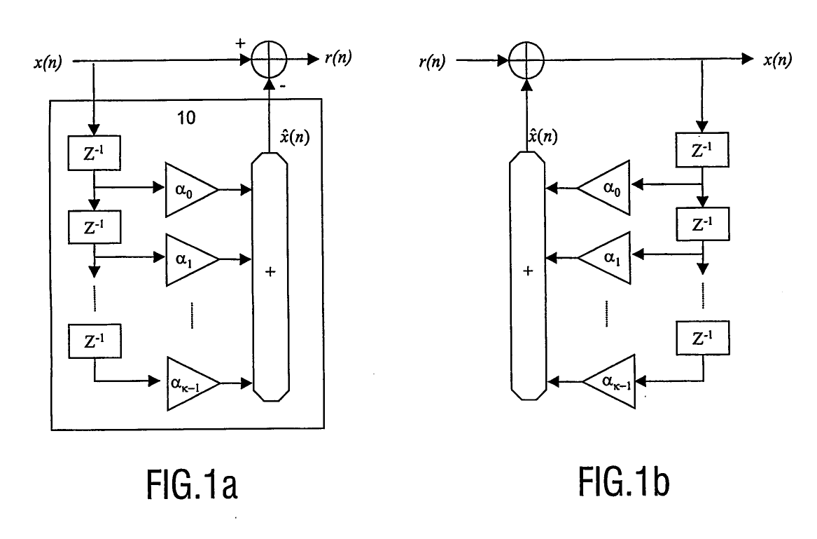

Linear predictive coding (LPC) is often employed in audio and speech coding. FIG. 1(a) shows a finite impulse response (FIR) type predictive filter 10 component of order K for a conventional LPC based encoder. The filter provides an estimate x(n) for a given signal x(n) generated from a linear combination of K previous samples of the signal. In the example of FIG. 1(a), the transfer function of the filter F(z) relating x(n) and r(n) can be represented as follows:

$$F ( z ) = 1 - {z}^{- 1} {\sum }_{k = 0}^{K - 1} {α}_{k} {z}^{- k} \qquad Equation 1$$

The prediction coefficients αₖ are calculated based on some criterion, typically a weighted mean-squared error.

The estimate \hat{x}(n) is in turn subtracted from the signal x(n) to provide a residual signal r(n). This residual signal and the information for the prediction filter i.e. the prediction coefficients α, are generally transmitted or stored in a more efficient form. For example, the prediction coefficients αₖ can be mapped onto a set of reflection coefficients, and these in turn can be mapped onto log area ratios (LAR). Alternatively, the prediction coefficients αₖ can be mapped directly to line spectral frequencies (LSF) prior to being encoded along with the residual signal in a bitstream representing the signal x(n). (In view of quantisation sensitivities, the LAR and LSF domains are preferred.) Alternative representations such as arcsine reflection coefficients (ASRCs) and Line Spectral Pairs (LSPs) may also be employed.

In a decoder, FIG. 1(b), the residual signal and the information for the prediction filter are used to reconstruct (or approximate) the original signal x(n). From FIG. 1 it is clear that similar mechanisms appear in the encoder and decoder. It is important to note, however, that to ensure the stability of the decoder, particularly in relation to distortion that may have been introduced into the signal during quantization prior to encoding the bitstream for the signal x(n) that the filter F(z) is typically a minimum-phase filter. That is to say that all of the roots (poles and zeros) of the transfer function F(z) must be inside the unit circle and this is in general feasible to ensure for FIR filters.

Using an FIR type filter of the type described above does not enable an encoder to be tuned taking into account a psycho acoustic model of the auditory process.

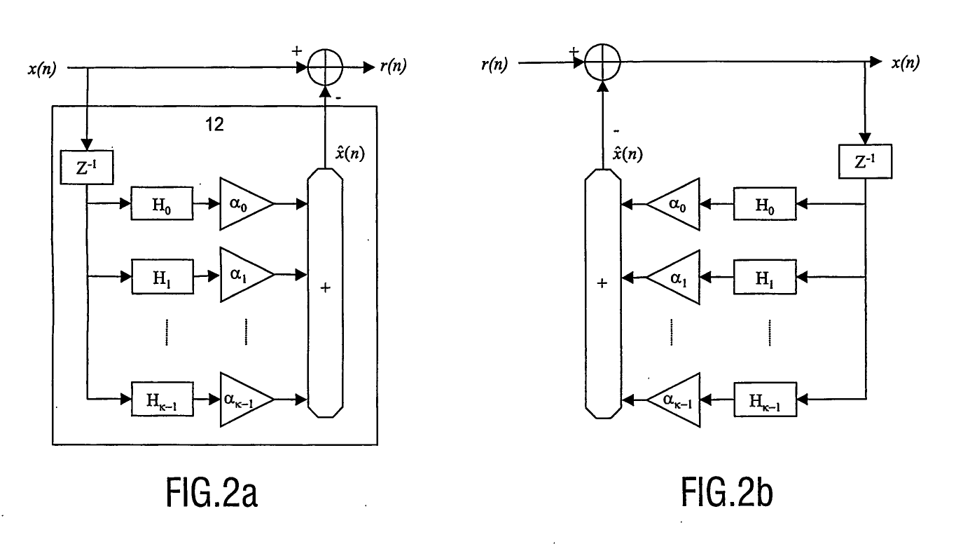

In “Alternatives for Warped Linear Predictors”, V. Voitishchuk et al., pp 710-713, Proc. ProRISC Workshop CSSP, Veldhoven (NL), 29-30 Nov. 2001 and “Stability of Linear Predictive Structures using IIR filters”, A. C. den Brinker, pp. 317-320, Proc. ProRISC Workshop CSSP, Veldhoven (NL), 29-30 Nov. 2001, it is shown that Laguerre and Kautz type filters which may be employed to tune an encoder/decoder towards ranges of frequencies of more interest and more normally thought of as Infinite Impulse Response (IIR) type filters may be represented in a form as shown in FIGS. 2(a) and 2(b).

The total transfer function for the filter of FIG. 2(a) relating x(n) and r(n) is:

$$F ( z ) = 1 - {z}^{- 1} {\sum }_{k = 0}^{K - 1} {α}_{k} {H}_{k} ( z ) \qquad Equation 2$$

where the set Hₖ is a transfer function belonging to a set of stable, causal, linear and linearly-independent filters.

It has been shown that choosing the set Hₖ as Laguerre filters, i.e.:

$${H}_{k} ( z ) = \frac{\sqrt{1 - {λ}^{2}}}{1 - {z}^{- 1} λ} {\{ \frac{{z}^{- 1} - λ}{1 - {z}^{- 1} λ} \}}^{k} \qquad Equation 3$$

where λε(−1, 1), the total transfer F may be a minimum-phase IIR filter.

Where λ is real and greater than 0 modelling is shifted to lower frequencies to which the human ear is more sensitive, whereas when λ is less than 0, modelling is shifted towards higher frequencies. Where λ=0 corresponds to the conventional case of FIG. 1.

There is, however, a problem in transmitting the prediction coefficients for filters of the type shown in FIG. 2 in that the roots of the polynomial

$$1 - {z}^{- 1} {\sum }_{k = 0}^{K - 1} {α}_{k} {z}^{- k}$$

associated with the prediction coefficients α alone may not provide a minimum phase filter and this may lead to instability in the decoder because of noise or distortion introduced during quantization of these parameters.

According to the present invention there is provided a method of encoding an audio signal as claimed in claim 1.

The preferred embodiments of the invention provide an extension of a conventional LPC scheme allowing Laguerre type prediction coefficients to be mapped to those of an FIR system. Therefore, conventional linear predictive coding techniques can be used to quantise and transmit or store the Laguerre prediction coefficients.

Embodiments of the present invention will now be described with reference to the accompanying drawings, in which:

FIGS. 1(a) and 1(b) show an encoder and decoder respectively for a conventional linear prediction structure;

FIGS. 2(a) and 2(b) show an encoder and decoder respectively for an alternative linear prediction scheme;

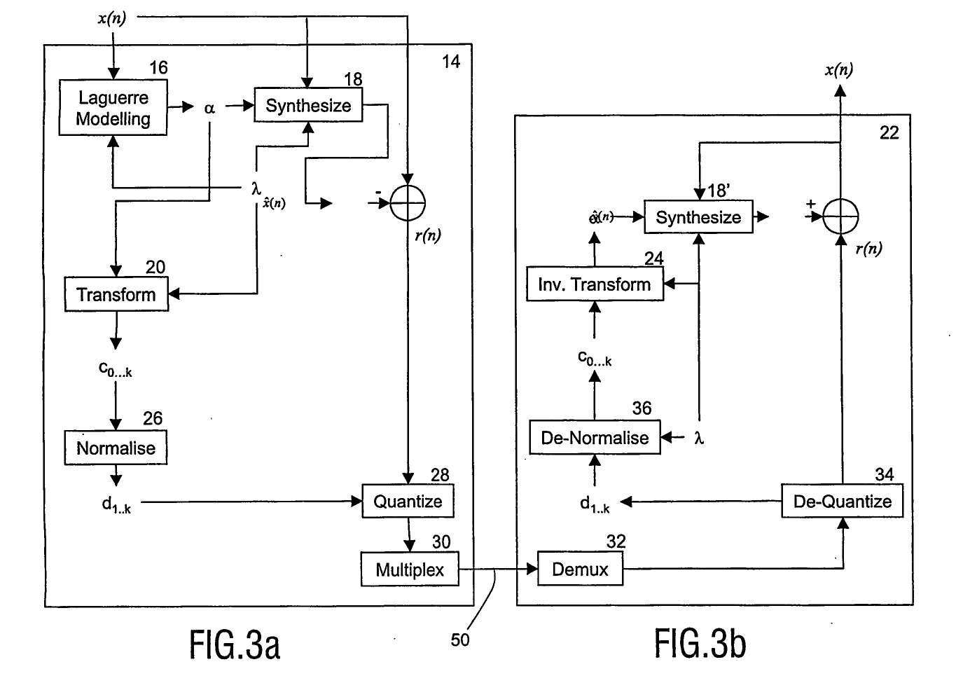

FIGS. 3(a) and 3(b) show an encoder and decoder respectively for a linear prediction scheme according to a first embodiment of the present invention;

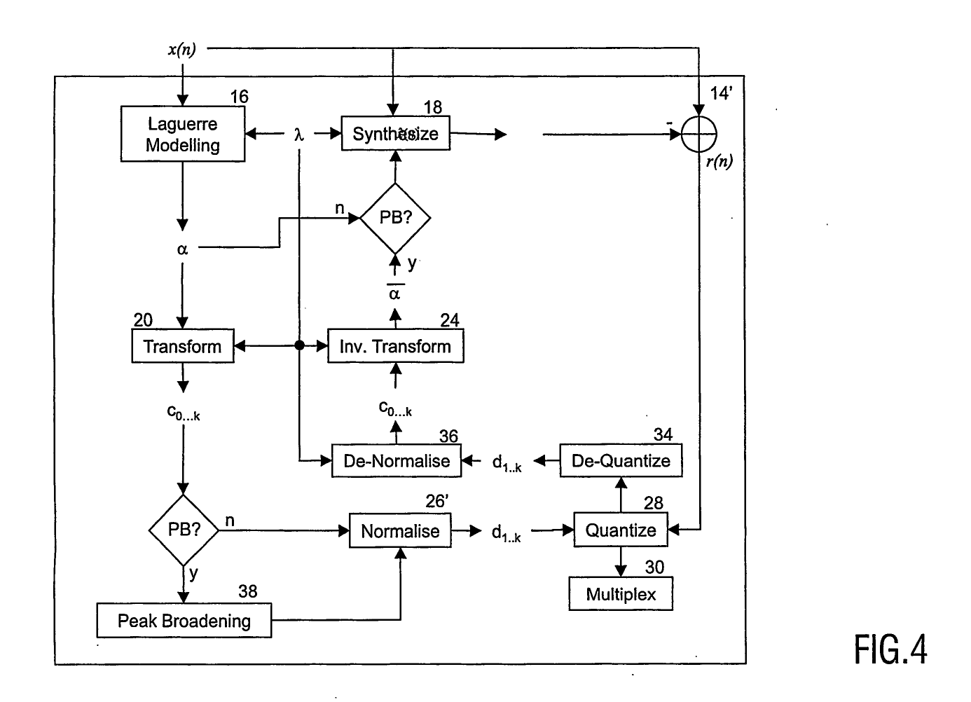

FIG. 4 shows an encoder according to a second embodiment of the invention;

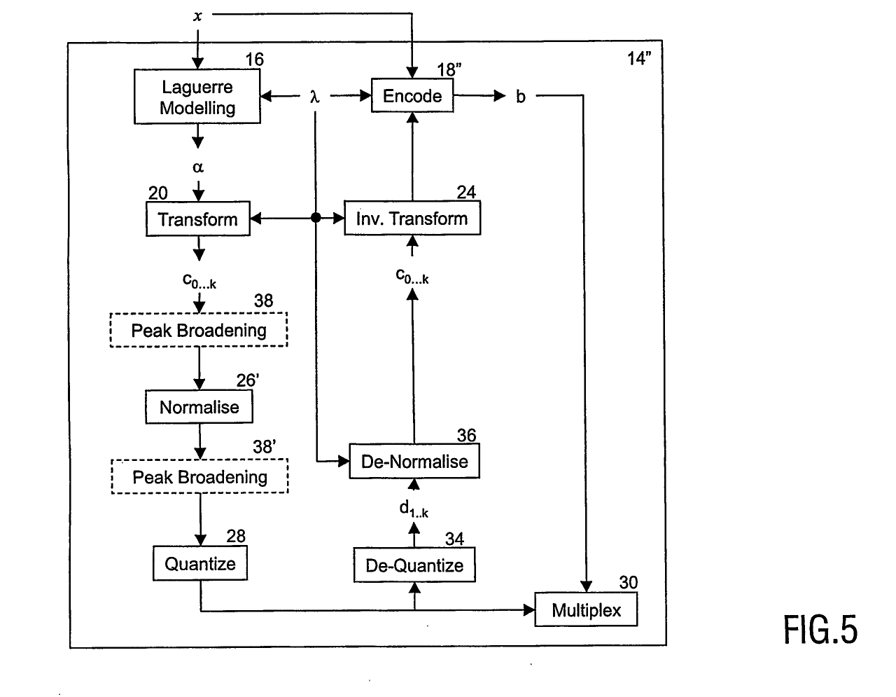

FIG. 5 shows a generic encoder encompassing the first and second embodiments of the invention; and

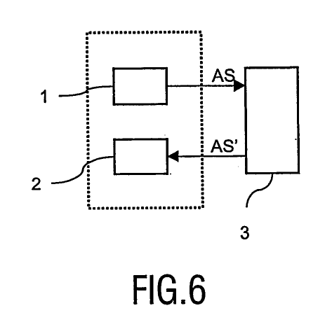

FIG. 6 shows a system comprising an audio coder and an audio player.

For a Laguerre type filter represented using the schema of FIG. 2, the total transfer function F(z) can be represented as a combination of equations 2 and 3:

$$F ( z ) = 1 - {\sum }_{k = 0}^{K - 1} {α}_{k} \sqrt{1 - {λ}^{2}} \frac{{z}^{- 1}}{1 - {z}^{- 1} λ} {( \frac{- λ + {z}^{- 1}}{1 - {z}^{- 1} λ} )}^{k} \qquad Equation 4$$

It is known that the transfer function F(z) can be a minimum-phase system if the coefficients are optimised using, for example, a data-input windowing method as disclosed by Voitishchuk et al and den Brinker.

In a first embodiment of the present invention, the above filter is mapped onto a minimum-phase FIR filter of order K, so that these Laguerre type prediction coefficients can be quantised and transmitted by standard techniques.

Referring now to FIG. 3(a) which shows an encoder 14 according to the first embodiment of the present invention. The encoder 14 includes a Laguerre filter component 16 of the type disclosed by by Voitishchuk et al and den Brinker. The component 16 is provided with a value of λ which determines the frequency sensitivity of the filter. This value may either be encoded in a bitstream 50 produced by the encoder for later use by a decoder 22, FIG. 3(b), or the value of λ may otherwise be known by the decoder 22.

For the signal x(n), the component provides a set of prediction coefficients α. These along with the λ value are supplied to a synthesizer component 18, which produces an estimate of signal \hat{x}(n) in the manner shown in FIG. 2(a).

In the preferred embodiments, however, the prediction coefficients α are transformed in a transformation component 20. The transformation carried out by the component 20 is illustrated using the form of an upper Triangular Toeplitz matrix as follows:

$$( \begin{matrix}{c}_{0} \\ {c}_{1} \\ {c}_{2} \\ … \\ {c}_{K - 1} \\ {c}_{K}\end{matrix} ) = ( \begin{matrix}1 & λ & 0 & … & 0 & 0 \\ 0 & 1 & λ & … & 0 & 0 \\ 0 & 0 & 1 & … & 0 & 0 \\ … & … & … & & … & … \\ 0 & 0 & 0 & … & 1 & λ \\ 0 & 0 & 0 & … & 0 & 1\end{matrix} ) ( \begin{matrix}1 \\ - {α}_{0} / p \\ - {α}_{1} / p \\ … \\ - {α}_{K - 2} / p \\ - {α}_{K - 1} / p\end{matrix} )$$

where α are the Laguerre prediction coefficients and p=\sqrt{1−|λ|²}. The K+1 coefficients c can be associated with a transfer function G(v) of a Kth-order FIR filter with

$$G ( v ) = {\sum }_{k = 0}^{K} {c}_{k} {v}^{- k} .$$

If the prediction coefficients α belong to a minimum-phase filter F(z), then G(v) represents a minimum-phase FIR filter.

In the decoder 22, FIG. 3(b), an inverse transformation is performed by a component 24 on the coefficients c₀ . . . cₖ generated by the forward transformation component. The component 24 is supplied with the same λ as employed by the encoder 14, and the transformation carried out by the component 24 is illustrated using the form of an upper Triangular Toeplitz as follows:

$$( \begin{matrix}1 \\ - {α}_{0} / p \\ - {α}_{1} / p \\ … \\ - {α}_{K - 2} / p \\ - {α}_{K - 1} / p\end{matrix} ) = ( \begin{matrix}1 & - λ & {( - λ )}^{2} & … & {( - λ )}^{K - 1} & {( - λ )}^{K} \\ 0 & 1 & - λ & … & {( - λ )}^{K - 2} & {( - λ )}^{K - 1} \\ 0 & 0 & 1 & … & {( - λ )}^{K - 3} & {( - λ )}^{K - 2} \\ … & … & … & & … & … \\ 0 & 0 & 0 & … & 1 & - λ \\ 0 & 0 & 0 & … & 0 & 1\end{matrix} ) ( \begin{matrix}{c}_{0} \\ {c}_{1} \\ {c}_{2} \\ … \\ {c}_{K - 1} \\ {c}_{K}\end{matrix} )$$

From this inverse transformation, it will be seen that:
The coefficients (c₀ . . . cₖ) adhere to a linear constraint, namely

$$1 = {\sum }_{k = 0}^{K} {{c}_{k} ( - λ )}^{k} \qquad Equation 5$$

The parameter c₀ can be considered as redundant since α₀ . . . αₖ₋₁ can be reconstructed from c₁ . . . cₖ, as follows:

$$( \begin{matrix}- {α}_{0} / p \\ - {α}_{1} / p \\ … \\ - {α}_{K - 2} / p \\ - {α}_{K - 1} / p\end{matrix} ) = ( \begin{matrix}1 & - λ & … & {( - λ )}^{K - 2} & {( - λ )}^{K - 1} \\ 0 & 1 & … & {( - λ )}^{K - 3} & {( - λ )}^{K - 2} \\ … & … & & … & … \\ 0 & 0 & … & 1 & - λ \\ 0 & 0 & … & 0 & 1\end{matrix} ) ( \begin{matrix}{c}_{1} \\ {c}_{2} \\ … \\ {c}_{K - 1} \\ {c}_{K}\end{matrix} )$$

Reverting back to the encoder 14, in the first embodiment, the coefficients c₀ . . . cₖ are passed to a normalising component 26. The component divides the coefficients c₀ . . . cₖ by the value of c₀ to provide a set of coefficients d₀ . . . dₖ. It will be seen, however, that the value of d₀ is always 1 and so the coefficients d₁ . . . dₖ correspond to the prediction coefficients of a minimum phase FIR filter of order K with transfer function

$$\overline{G} ( v ) = {\sum }_{k = 0}^{K} {d}_{k} {v}^{- k} ,$$

if the coefficients c₀ . . . cₖ in turn represent a minimum phase filter. Since the normalisation carried out in component 26 is merely a division of all coefficients by some factor, the order of the transformation component 20 and the normalisation component 26 can be changed, i.e. we can do first normalisation and then transformation. In the encoder this requires the calculation of c₀ first with corresponding changes afterwards. It will also be seen that the same change in order of inverse transformation and de-normalisation can be made in the decoder explained later.

The normalising component 26 passes the coefficients d₁ . . . dₖ to a component 28 where the coefficients are transformed preferably into LAR or LSF parameters and quantized in a corresponding manner to the quantization of the a coefficients of FIG. 1(a) except that indexing is different and the signs have been reversed. The component 28 also receives the residual signal r(n), quantizes this as appropriate and passes the values to a multiplexing unit 30 which generates a bitstream 50 representing the signal x(n). It will therefore be seen that this bitstream can be transmitted in the same form as with a bitstream containing conventional FIR filter parameters. Alternatively, the bitstream may be slightly modified to include at some point the value of λ, but otherwise, its format need not be changed.

Turning now to the decoder 22, FIG. 3(b), the bitstream 50 is decoded by a de-multiplexing unit 32. The extracted parameters are provided to a de-quantizing component which produces the residual signal r(n) and the normalized FIR type filter parameters d₁ . . . dₖ in a conventional manner.

A de-normalizing component 36 is employed first of all to determine the value of c₀. From equation 5, it can be seen that:

$${\sum }_{k = 0}^{K} {{d}_{k} ( - λ )}^{k} = {\sum }_{k = 0}^{K} \frac{{c}_{k}}{{c}_{0}} {( - λ )}^{k} = \frac{1}{{c}_{0}} \qquad Equation 6$$

and so the component 36 when provided with the value λ used in the encoder can use the equation:

$${c}_{0} = {( {\sum }_{k = 0}^{K} {{d}_{k} ( - λ )}^{k} )}^{- 1} \qquad Equation 7$$

to determine the value for c₀. For equation 7, it should be noted that while the de-normalizing component is only provided with parameters d₁ . . . . dₖ, it can assume that d₀=1. Thus, once c₀ has been determined the remaining coefficients c₁ . . . cₖ are determined by the component 36 as follows:
cₖ=dₖc₀ Equation 8
The coefficients c₀ . . . cₖ are provided by the de-normalizing component 36 to the inverse transformation unit 24 described above, and this provides the set of Laguerre filter prediction coefficents α which can in turn be used by a decoder synthesizer component 18′ as shown in FIG. 2(b) to produce the estimated signal \hat{x}(n). This is combined with the residual signal r(n) supplied by the de-quantizer component 34 to provide the finally decoded signal x(n).

It will be seen that variations of the preferred embodiment are possible. For example, in a second embodiment of the invention, FIG. 4, an adapted encoder 14′ provides peak broadening or bandwidth extension/expansion/widening as disclosed in “Spectral smoothing technique in PARCOR speech analysis-synthesis”, Y. Tohkura and F. Itakura and S. Hashimoto, IEEE Trans. Acoust. Speech Signal Process. vol. 26, pp. 587-596, 1978. Spectral peak broadening in linear prediction coding is done by multiplying the impulse response (prediction coefficients) by an exponentially-decreasing sequence.

In relation to the present invention, peak broadening is implemented by interposing a peak broadening component 38 between the transform component 20 and an adapted normalizing component 26′ of the first embodiment.

After the transformation of the original Laguerre filter type prediction coefficients α to the coefficients c₀ . . . cₖ, the encoder determines if peak broadening is required. If so, the coefficients c₀ . . . cₖ are passed to the peak broadening component 38. This multiplies the coefficients c₀ . . . cₖ with a peak broadening response, for example, of the form:
\tilde{c}ₖ=cₖwₖ, where wₖ=γ^{k} and 0<γ≦1 Equation 9
As before, a linear constraint needs to be applied to the coefficients \tilde{c}. Thus, if supplied with a peak broadened set of coefficients, either the component 38 or 26′ determines a multiplier c_{f} as follows:

$${c}_{f} = {\sum }_{k = 0}^{K} {{\tilde{c}}_{k} ( - λ )}^{k} \qquad Equation 10$$

The coefficients \tilde{c}ₖ are divided by this multiplier \tilde{c}ₖ=\tilde{c}ₖ/c_{f} so that the resulting coefficients \overline{c} fulfil the constraints of equation 5. The normalising component 26′ can then normalise the coefficients \overline{c}₁ . . . \overline{c}ₖ to provide the normalised type FIR coefficients d_{1 . . . k} as before.

It will be seen that the peak broadening affects the signal which will eventually be synthesized within a decoder reading the peak broadened signal, and as such a different residual signal r(n) should be calculated within the encoder 14′ if peak broadening has been applied.

Thus, in the second embodiment, a de-quantizer component 34 as in FIG. 2(b) is provided with the quantized signal produced by the component 28 to provide the coefficients d_{1 . . . k} exactly as they would be generated within the decoder. These are in turn de-normalised and inversely transformed by components 36 and 24 respectively, again corresponding to the components of FIG. 2(b), to produce a set of prediction coefficients \overline{α} as would be generated within the decoder for the peak broadened signal. The synthesizer 18 then either uses the prediction coefficients \overline{α} or α according to whether peak broadening has been applied or not and subtracts this from the signal x(n) to generate the residual signal r(n).

It will be seen that, if the coefficients \tilde{c}₀ . . . \tilde{c}ₖ or \overline{c}₀ . . . \overline{c}ₖ were provided directly to the inverse transform component 24, the same prediction coefficients \overline{α} would not be provided as above. Nonetheless, this would obviate the need for the components 34 and 36 within the encoder and may be acceptable where an encoder is computationally limited.

When a bitstream to which such peak broadening is decoded, the resulting prediction coefficients \overline{α} are the coefficients of a spectrally peak broadened Laguerre prediction filter, where peak broadening has been carried out in a frequency warped domain. This means that the encoder is in fact performing peak broadening on a psycho-acoustically relevant scale and also allow the peak broadening function, for example, wₖ, to be chosen on the basis of its pyscho-acoustical function.

It will be seen that in variations of the second embodiment, peak broadening could be applied to the coefficients d_{1 . . . k}, rather than the coefficients c_{0 . . . k} with the appropriate changes required for the generation of the residual signal.

As explained above, it is desireable to ensure that the prediction coefficients used within the encoder will be the same as those employed within the decoder to generate the final estimate of the original audio signal. FIG. 5 shows a more general form of encoder 14″ encompassing the encoders of the first and second embodiments. In this encoder, the steps of transforming, normalising, quantizing and optionally peak broadening are performed as before by components 20, 26′, 28 and 38/38′ respectively. (In FIG. 5, the components 38/38′ indicate that peak broadening may occur either before 38 or after 38′ normalizing)

In the general form of encoder, however, the quantized signal is fed through de-quantizing, de-normalizing and inverse transform components 24, 26 and 24 respectively as in the second embodiment to ensure that the prediction coefficients employed by the encoder to generate the residual signal will be exactly the same as those employed in the decoder.

It will also be seen from FIG. 5 that the invention is not limited to the generation of a residual signal r(n) by synthesizing the signal \hat{x}(n) and subtracting this from the signal x(n) as in the first two embodiments. This aspect of the invention can be thought of more generally as including an encoder 18″ which ideally uses the prediction coefficients which will be employed in the decoder and the frequency sensitizing parameter λ to generate an indication b of the difference between the modelled aspect of the signal \hat{x}(n) and the signal itself x(n).

In the decoder (not shown), a corresponding component combines this indication b with the prediction coefficients and the frequency sensitizing parameter λ to generate the final estimate of the original audio signal.

FIG. 6 shows an audio system according to the invention comprising an audio coder 1 including the encoder 14,14′ as shown in FIG. 3(a) or 4 and an audio player 3 including the decoder 22 as shown in FIG. 3(b). The encoded audio stream 50 is furnished from the audio coder to the audio player over a communication channel 2, which may be a wireless connection, a data bus or a storage medium. In case the communication channel 2 is a storage medium, the storage medium may be fixed in the system or may also be a removable disc, solid state storage device such as a Memory Stick™ from Sony Corporation etc. The communication channel 2 may be part of the audio system, but will however often be outside the audio system.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding an audio signal, the method comprising the steps of:
modelling the audio signal in accordance with a frequency sensitizing parameter to provide a first set of infinite impulse response filter type characteristics of an order K capable of being linearly combined with said sensitizing parameter to provide an estimate for said audio signal;
transforming said first or a third set of characteristics as a function of said sensitizing parameter to provide a second set of characteristics compatible with finite impulse response filter type characteristics;
normalising said first or said second set of characteristics to provide said third set of characteristics; and
generating an encoded audio stream including representations of a transformed and normalised set of characteristics of order K.

2. A method as claimed in claim 1 wherein said UIR filter type filter characteristics satisfy the requirements of a minimum phase filter and said FIR filter type characteristics satisfy the requirements of a minimum phase filter.

3. A method according to claim 1 further comprising the step of:
subtracting said estimate from said audio signal to provide a residual signal; and wherein said generating step includes including said residual signal in said encoded audio stream.

4. A method according to claim 1 wherein said modelling step comprises modelling said audio signal with a Laguerre type filter having a transfer function:
$$F ( z ) = 1 - {\sum }_{k = 0}^{K - 1} {α}_{k} \sqrt{1 - {λ}^{2}} \frac{{z}^{- 1}}{1 - {z}^{- 1} λ} {( \frac{- λ + {z}^{- 1}}{1 - {z}^{- 1} λ} )}^{k}$$

5. A method according to claim 4 wherein said transformation step comprises transforming said Laguerre filter coefficients according to the matrix transformation:
$$( \begin{matrix}{c}_{0} \\ {c}_{1} \\ {c}_{2} \\ … \\ {c}_{K - 1} \\ {c}_{K}\end{matrix} ) = ( \begin{matrix}1 & λ & 0 & … & 0 & 0 \\ 0 & 1 & λ & … & 0 & 0 \\ 0 & 0 & 1 & … & 0 & 0 \\ … & … & … & & … & … \\ 0 & 0 & 0 & … & 1 & λ \\ 0 & 0 & 0 & … & 0 & 1\end{matrix} ) ( \begin{matrix}1 \\ - {α}_{0} / p \\ - {α}_{1} / p \\ … \\ - {α}_{K - 2} / p \\ - {α}_{K - 1} / p\end{matrix} )$$
wherein p=\sqrt{1−|λ|²}.

6. A method according to claim 5 wherein said normalising step comprises dividing said second set of characteristics of order K+1 by one of said second set of characteristics and providing the remainder of said divided set of characteristics as said third set of characteristics of order K.

7. A method according to claim 1 wherein said generating step includes said frequency sensitizing parameter in said bitstream.

8. A method according to claim 1 further comprising the step of:
peak broadening said set of characteristics of order K+1.

9. Method of decoding an audio stream, the method comprising the steps of:
reading an encoded audio stream containing representations of an audio signal to provide a first set of characteristics of an order K compatible with finite impulse response filter type characteristics;
combining said first set of characteristics of order K with a frequency sensitizing parameter to provide a de-normalising characteristic;
de-normalising said first or a third infinite impulse response filter type set of characteristics as a function of said de-normalising characteristic to provide a second set of characteristics;
transforming said first or said second set of characteristics as a function of said sensitizing parameter to provide said third set of characteristics; and
synthesizing the audio signal as a linear combination of said frequency sensitizing parameter and a set of de-normalised and transformed characteristics of order K.

10. Audio coder, comprising:
means for modelling an audio signal in accordance with a frequency sensitizing parameter to provide a first set of infinite impulse response filter type characteristics of an order K capable of being linearly combined with said sensitizing parameter to provide an estimate for said audio signal;
means for transforming said first or a third set of characteristics as a function of said sensitizing parameter to provide a second set of characteristics compatible with finite impulse response filter type characteristics;
means for normalising said first or said second set of characteristics to provide said third set of characteristics; and
means for generating an encoded audio stream including representations of a transformed and normalised set of characteristics of order K.

11. Audio player, comprising:
means for reading an encoded audio stream containing representations of an audio signal to provide a first set of characteristics of an order K compatible with finite impulse response filter type characteristics;
means for combining said first set of characteristics of order K with a frequency sensitizing parameter to provide a de-normalising characteristic;
means for de-normalising said first or a third infinite impulse response filter type set of characteristics as a function of said de-normalising characteristic to provide a second set of characteristics;
means for transforming said first or said second set of characteristics as a function of said sensitizing parameter to provide said third set of characteristics; and
means for synthesizing the audio signal as a linear combination of said frequency sensitizing parameter and a set of de-normalised and transformed characteristics of order K.

12. Audio system comprising an audio coder as claimed in claim 10 and an audio player as claimed in claim 11.

13. Audio stream comprising representations of an audio signal corresponding to a set of characteristics of an order K, said set of characteristics of order K being combinable with a frequency sensitizing parameter to provide a set of characteristics of order K+1 compatible with finite impulse response filter type characteristics; said set of characteristics of order K+1 being transformable as a function of said sensitizing parameter to provide a set of infinite impulse response filter type characteristics of order K.

14. Storage medium on which an audio stream as claimed in claim 13 has been stored.
